(19) United States
(12) Patent Application Publication
(10) Pub. No.: US 2010/0088171 A1
(43) Pub. Date: Apr. 8, 2010

(54) System and method for providing magazine subscriptions to consumers

(76) Inventors: Michael J. Borchetta, Stamford, CT (US); Michael D. Frank, New Canaan, CT (US); David M. Rock, Stamford, CT (US)

Correspondence Address: ABELMAN, FRAYNE & SCHWAB, 666 THIRD AVENUE, 10TH FLOOR, NEW YORK, NY, 10017, US

(21) Appl. No.: 12/586,526

(22) Filed: Sep. 22, 2009

Related U.S. Application Data
(60) Provisional application No. 61/195,239, filed on Oct. 2, 2008.

(51) Int. Cl. G06Q 50/00; G06Q 30/00; G06Q 90/00

(52) U.S. Cl. 705/14.23; 705/26; 705/500

(57) ABSTRACT

A method and apparatus fulfill a periodical subscription to a consumer, where the periodical subscription includes a predetermined number of issues and associated delivery dates. The method and apparatus receive a subscription order for a periodical having a plurality of issues deliverable to the consumer at a consumer premise; and generate a subscription order voucher for redeeming an interim periodical issue prior to the consumer receiving delivery of a first issue of the subscription at the consumer premises from a fulfillment house. The voucher includes authorization for a retail location to provide the interim issue of the periodical subscription to the consumer upon presentation. The subscription agent communicates subscription information associated with the consumer to the fulfillment house following one of redemption of the voucher by the consumer for the interim issue or a predetermined time having elapsed.

### CROSS REFERENCE TO RELATED APPLICATION

This patent application claims the benefit of U.S. Provisional Application Ser. No. 61/195,239, filed Oct. 2, 2009, the contents of which are incorporated by reference herein in its entirety.

### FIELD OF THE INVENTION

The present invention relates generally to distributing new subscriptions of periodicals to consumers, and more specifically to a system and method for distributing at least one issue of a periodical of a new subscription through a retail channel.

### BACKGROUND OF THE INVENTION

Each year, millions of single-issue copies of magazines are sold through thousands of retail outlets in the United States. The cost of a single issue copy, or the “cover price,” is often two, three or four times higher than the pro rata price of a single issue of the same periodical purchased through a subscription. Despite the higher prices, consumers are willing to purchase single issues from retail outlets because of convenience and timeliness.

Some consumers decide to forgo the advantages of newsstand or other retail copies and purchase periodicals by subscription. There are many channels to purchase a subscription to a periodical. For example, if a consumer wishes to subscribe to a magazine, the consumer may purchase a single issue at a retail outlet and mail back a “blow-in” or “bind-in” card enclosed in the magazine. Publishers place blow-in subscription cards by loosely inserting the cards into periodicals, such as magazines, by air injection. Publishers can also insert bind-in cards into the magazine issues during the printing process. Publishers use these methods to sell subscriptions because of the potential profits earned thereon. Nevertheless, many inconveniences arise from the traditional methodologies, which do not promote, and in fact hinder, customers of single issues from subscribing to the periodicals.

One such inconvenience involves lost sales to the retailer. Retailers carry single-issue periodicals predominantly for impulse purchases. However, if a consumer purchases a single-issue periodical at a retail outlet and then subscribes to the periodical by a blow-in or bind-in card, the retailer earns no additional revenue from the subscription. In addition, subscription cards contained in retail copies encourage consumers to buy a subscription that deprives the retailer of potential revenue from future single-issue sales to that customer. Thus, retailers have no incentive to encourage purchasers of single issues to purchase subscriptions.

Several other inconveniences affect the consumer. For example, the initiation of a subscription by a blow-in or bind-in subscription card requires much time and patience on the part of the consumer. Such a subscription frequently takes weeks for processing. Indeed, federal rules require, when appropriate, that magazine publishers denote a waiting time disclaimer: “Allow 4-8 weeks for your first issue to be mailed.” In addition, due to processing and delivery delays, the consumer may not actually receive the first issue of the magazine until twelve weeks from the date of subscription. The uncertainty of when the first issue of the subscription will arrive often results in missed issues. In addition, purchasing subscriptions using subscription cards creates a risk of loss to the consumer because the consumer must deposit the subscription card in the mail, after which the consumer has no record or invoice of the transaction.

U.S. Pat. No. 5,926,796 to Walker et al., which is incorporated by reference herein in its entirety, discloses a subscription system and method which includes integrating the sale of a subscription along with the sale of a single-issue periodical at a retailer. After a customer selects a single issue of a periodical for purchase, a cashier at a POS (point-of-sale) terminal of the retailer queries the customer as to whether he/she desires to purchase a subscription to that periodical. If the customer declines the subscription, the cashier at the POS terminal proceeds with a conventional sale of the single issue. If the customer accepts a subscription, the customer completes a subscription card/form, which is returned to the cashier at the POS terminal. The cashier at the POS terminal scans a bar code on the single issue to capture the identification information of the periodical title and the single-issue price pursuant to the Uniform Produce Code (UPC), or bar code, located thereon. The subscription price and number of issues is also entered at the POS terminal. The subscription identification information is subsequently sent electronically to a fulfillment house, which will distribute the subscription periodical in a well-known manner. The customer pays for the subscription in a well-known manner (e.g., cash, credit card, etc.) and receives the single issue as the first issue of the subscription to the periodical.

U.S. Pat. No. 6,535,857 to Clarke, III et al., which is also incorporated by reference herein in its entirety, sought to overcome the latency effects that occur in the periodical publishing and distribution industry by distributing early issues of a periodical subscription to a consumer. In particular, the method involves a redirection of periodicals from a retail point of sale to a consumer, during an interim period from a time when a subscription request is made and conventional delivery of the subscription begins. A consumer places an order for a subscription to a periodical, which is to be delivered to the consumer. Then, a subscription agent or other entity determines when the subscription (by conventional delivery mechanisms) will start being delivered to the consumer (i.e., which issue will be the first issue received by the consumer). Then, interim issues are redirected from a retail point of sale to the consumer premises. In one distribution method, a wholesale distributor may redirect unsold periodicals from a retail point of sale to a consumer premises. More particularly, unsold issues of a periodical that are normally retrieved by a wholesale distributor and delivered to a shredder/recycler may be mailed or otherwise distributed to a consumer until the consumer begins to receive the subscription through conventional distribution mechanisms.

Another attempt to overcome the inconveniences of the traditional subscription methodologies included the retail sale of subscriptions at bookstores. The subscriptions were offered as part of a shelf-displayed package placed on a hook. The consumer could purchase one of the packages and subscribe to a periodical by paying for the package at the retail point-of-sale and then sending the pre-paid subscription activation card to the fulfillment house. Still another attempt incorporated the sale of subscriptions at specialty subscription kiosks. These kiosks comprised a computer system utilizing touch-screen technology to enable consumers to select and purchase either a subscription or a gift subscription. The customer could pay for either type of subscription at the kiosk by credit card, and the kiosk would issue a receipt for the transaction. For gift subscriptions, the subscription kiosk would also dispense a gift card. For both types of subscriptions, the kiosks informed consumers of a four-to-eight week delay before the arrival of the first issue.

Again, none of these attempts solved the inconveniences of the traditional subscription methodologies. Rather, these attempts experienced significant delays due to processing requirements. Indeed, the subscription kiosk attempt specified a four-to-eight week delay. In addition, none of these attempts allowed the consumer to receive the current issue of the periodical with the subscription. Also, the attempts made no provision for a consumer to benefit from a subscription in the price of the current issue.

In all of the above attempts, significantly, the consumer never had the opportunity to purchase a single issue with the subscription, that is, where the subscription included the single issue in the price of the subscription. Indeed, whether or not these attempts were transmitted through a processing center, they all comprised invoice orders for the initiation of a simple subscription. As such, they all suffered at least one common inconvenience associated with the traditional subscription methodologies, namely, the inability to incorporate the current issue as the first issue of a subscription. Additionally, as illustrated above, all the cited attempts also suffered other common inconveniences because they all resulted at least in the loss of a sale of the initial single issue to the retail outlet and they all entailed significant processing delay resulting in a customer not receiving the most current issue of the periodical.

### SUMMARY OF THE INVENTION

In one aspect of the present invention, a novel method is provided for fulfilling a periodical subscription to a consumer, where the periodical subscription includes a predetermined number of issues and associated delivery dates. The method includes the steps of receiving a subscription order for a periodical having a plurality of issues deliverable to the consumer at a consumer premise; and generating a subscription order voucher for redeeming an interim periodical issue prior to the consumer receiving delivery of a first issue of the subscription at the consumer premises from a fulfillment house. The voucher includes authorization for a retail location to provide the interim issue of the periodical subscription to the consumer upon presentation. The subscription information associated with the consumer is communicated to the fulfillment house following one of redemption of the voucher by the consumer for the interim issue or a predetermined time having elapsed.

In another embodiment, a subscription agent communicates subscription information associated with the consumer to the fulfillment house. Alternatively, a publisher or other entity can communicate the subscription information associated with the consumer to the fulfillment house.

In a further embodiment, the interim issues of the periodical are distributed to the consumer at a subscription price. Alternatively, the interim issues are distributed to the consumer at a discounted price (e.g., a price other than the subscription or cover price of the issue).

In yet another embodiment, a subscription is directed to a subscription agent electronically via a subscription transaction website or by telephone. Alternatively, a subscription is directed to a subscription agent from a retail outlet.

In one embodiment, the voucher includes the name of the periodical or magazine of the subscription and at least one retail outlet where the voucher can be redeemed in exchange for an interim issue of the subscription. In yet another embodiment, the voucher includes the terms of the subscription and/or indicia of the subscriber.

In another aspect of the present invention, a system is provided for fulfilling a periodical subscription to a consumer, where the periodical subscription includes a predetermined number of issues and associated delivery dates. The system includes a computer device having at least one processor and memory for storing a periodical subscription module operable to receive, at a subscription agent, a subscription order for a periodical having a plurality of issues deliverable to the consumer at a consumer premises; and generate a subscription order voucher for redeeming an interim periodical issue prior to the consumer receiving delivery of a first issue of the subscription at the consumer premises from a fulfillment house. The voucher includes authorization for a retail location to provide the interim issue of the periodical subscription to the consumer upon presentation. The system is further operable to communicate subscription information associated with the consumer to the fulfillment house following one of redemption of the voucher by the consumer for the interim issue or a predetermined time having elapsed.

In yet another aspect of the present invention, an apparatus is provided for fulfilling a periodical subscription to a consumer, where the periodical subscription includes a predetermined number of issues and associated delivery dates. The apparatus includes means for receiving, at a subscription agent, a subscription order for a periodical having a plurality of issues deliverable to the consumer at a consumer premises; means for generating a subscription order voucher for redeeming an interim periodical issue prior to the consumer receiving delivery of a first issue of the subscription at the consumer premises from a fulfillment house, the voucher including authorization for a retail location to provide the interim issue of the periodical subscription to the consumer upon presentation; and means for communicating subscription information associated with the consumer to the fulfillment house following one of redemption of the voucher by the consumer for the interim issue or a predetermined time having elapsed.

### BRIEF DESCRIPTION OF THE DRAWINGS

FIG. 1 is a block diagram of a periodical subscription distribution environment in accordance with the present invention;

FIG. 2 is block diagram of a computer device suitable for use in the environment of FIG. 1;

FIG. 3 is a flow diagram for a method for distributing interim issues of a periodical subscription to a subscriber at a point-of-sale location;

FIG. 4 is a graphical illustration of a first embodiment of a voucher for redeeming an interim issue of a subscription according to the present invention; and

FIG. 5 is a graphical illustration of another embodiment of a voucher for redeeming an interim issue of a subscription according to the present invention

To facilitate understanding of the invention, the same reference numerals have been used when appropriate, to designate the same or similar elements that are common to the figures. Unless stated otherwise, the drawings shown and discussed in the figures are not drawn to scale, but are shown for illustrative purposes only.

### DETAILED DESCRIPTION OF THE PREFERRED EMBODIMENTS

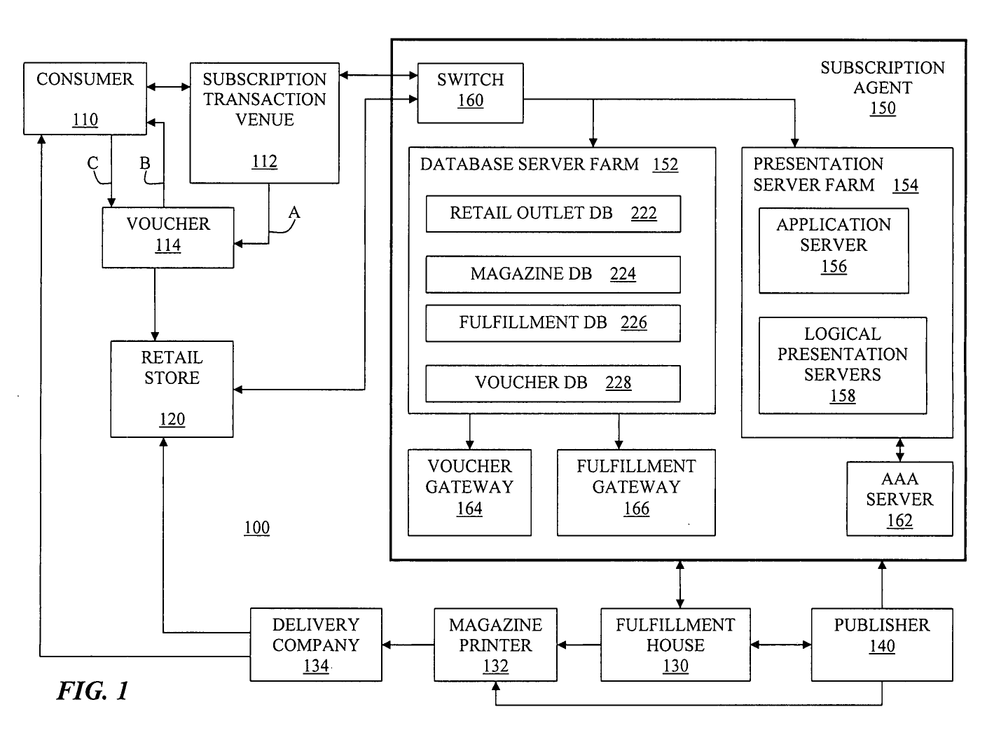

As shown in FIGS. 1-4, the present invention provides a system and method for distributing early issues of a periodical subscription to a consumer. Generally, the system and method involves providing periodicals from a retail point of sale to a consumer, during an interim period from a time when a subscription request is made and conventional delivery of the subscription begins. More specifically, in accordance with one aspect of the invention, a consumer places a periodical subscription order, which is transmitted or otherwise forwarded to a subscription agent for initial processing. The subscription agent receives the subscription order and generates a voucher, which is transferred or otherwise delivered to the consumer for redemption at a retail outlet of the consumer's choosing. The consumer can use the voucher to redeem at least one single issue periodical of the subscription from a retail outlet prior to the consumer receiving the first delivery of the subscription at the consumer's premises from a fulfillment house.

The voucher includes authorization and instructions for a retail outlet to provide a consumer with a single issue copy, which serves as an interim provided issue of the periodical subscription upon presentation of the voucher. Once the consumer redeems the first issue of the subscription from the retail outlet, the retailer notifies the subscription agent of the first issue redemption. The subscription agent in turn communicates the subscription information associated with the consumer to the fulfillment house, which notifies the publisher, magazine printer and other entities to provide the new subscription to the consumer in a well-known manner. In the event that the consumer does not present the voucher to a retail outlet to redeem the interim issue within a predetermined time, the subscription agent will communicate the consumer subscription information to the fulfillment house upon such predetermined time lapsing.

In an alternate embodiment, the voucher can be used to receive multiple successive issues of the subscription prior to the consumer receiving the remaining subscription issues at their premises (e.g., mailing address). For example, a voucher can be used to receive two or more sequential issues at the retail outlet prior to the first delivered subscription issue being received at the consumer premises. Alternatively, a new voucher can be provided to the consumer to redeem each sequential issue at the retail outlet.

The following definitions are provided for purposes of better understanding the present invention. The terms “single issue” or “cover issue” refers to a copy of a magazine or other periodical that is available for sale at a retail outlet. The term “first issue” refers to a magazine or other periodical that a consumer has subscribed for a predetermined number of issues and/or time, and is the first of the predetermined number of issues.

Referring to FIG. 1, a block diagram of a subscription periodical distribution system 100 of the present invention is illustratively shown. As illustrated, the principal entities involved in the subscription system 100 include a publisher 140, a fulfillment house 130, a magazine printer 132, a delivery company 134, at least one retail store 120, a subscription agent 150, a subscription transaction venue 112, and a consumer 110 who purchases a single issue of or subscription to a magazine and/or other periodical.

The publishers 150 may include entities such as Time, Hearst, Conde Nast, etc, who are responsible for planning, compiling, editing, etc. a given periodical. National distributors include entities such as Time Warner Inc., Curtis Circulation Company, etc., who typically contract with a publisher 140 to handle certain aspects of a periodical distribution, namely billing/collection and marketing/sales support. Printers 132 print the periodicals and include entities such as Quad Graphics, World Color Press, etc. The national distributor typically communicates delivery requirements and delivery addresses to the printer 132. In addition, the printer 132 typically has a relationship with the publisher 140, whereby the publisher 140 pays the printing costs associated with the printing of a given periodical. Wholesale distributors include entities such as Anderson News Corporation, News Group, Source Interlink, Hudson News Company, etc. Wholesale distributors and national distributors typically work together so that the national distributor can allocate a sufficient number of copies to the wholesale distributor for distribution to the consumer base of the wholesale distributor. Retailers 120 include entities such as Wal-Mart, Target, independent newsstands, etc. Typically, wholesale distributors contract with retailers 120 for the allotment and sale of periodicals and other publications. Finally, consumers 110 typically purchase single-copy issues of periodicals from retailers 120. The single-copy issues purchased at retail points of sale are priced at typically three to four times the amount paid for subscription periodicals.

Some consumers decide to forgo the advantages of retail copies and purchase longer-term subscriptions to periodicals. There are a wide variety of well-known methods for subscribing to a periodical. For example, if a consumer wishes to subscribe to a magazine, the consumer may purchase a single issue at a retail outlet and mail back a “blow-in” or “bind-in” card enclosed in the magazine issue. Publishers place blow-in subscription cards by loosely inserting the cards into periodicals, such as magazines, using a method of air injection. Publishers insert bind-in cards into the periodicals by, for example, binding subscription cards into issues during the printing process. Publishers acknowledge that subscription cards are the most profitable means for the publisher to gain circulation.

The fulfillment houses 130 include entities such as CDS, Palm Coast Data, Kable, etc. Much like the role of a national distributor in the context of the retail distribution of periodicals, a fulfillment house 130 typically contracts with a publisher 140 to manage certain aspects of the subscription distribution of periodicals. Specifically, a fulfillment house 130 is authorized by a publisher 140 to interface with a subscription agent 150 to collect remittances from the subscription agent 150, as well as to provide information and instructions to the printer 132 regarding the identification and mailing of subscription publications to subscribers 110.

Subscription agents 150 include entities such as M2 Media Group, Special Data Processing, Publishers Clearinghouse, as well as others. For example, a publisher or other entity can function as a subscription agent 150 to provide subscription information to a fulfillment house. A subscription agent 150 is an entity that interfaces with a subscriber 110 to obtain both payment and information in exchange for a periodical subscription (for a certain price) to cover a prescribed number of issues of a periodical. In manners that are well known, subscription agents 150 may interface with a subscriber 110 by receiving mailed in bind-in or blow-in cards, which the subscriber 110 may have retrieved from a prior issue of a periodical and filled out. Subscription agents 150 may also interface with subscribers over the telephone, through field agents, computer terminals, or other subscription transaction venues 120. Preferably, a consumer 110 can place an order or otherwise subscribe to one or more periodical subscriptions by accessing, for example, a retail store or a website of a subscription agent over the Internet from their home, a retail outlet or other convenient location.

Generally, the information obtained from the subscriber will include an identification of the subscriber (e.g., name, address, telephone number, etc.), and identification of the periodical that the subscriber 110 desires, the subscription term selected by the subscriber, and payment for this subscription (check, money order, cash, credit card authorization, etc.) This information is communicated from the subscription agent 150 to the fulfillment house 110. This information is relayed from the fulfillment house 130 to both the printer 132 as well as the publisher 140. Based upon the information relayed to the printer, the printer 132 distributes (e.g., via mail) magazines to the subscriber 110. Based upon the information provided from the fulfillment house 130 to the publisher 140, the publisher 140 remits payment to the printer 132. As also illustrated, the fulfillment house 130 provides information to subscription agents 150, and publishers 150 provide authorization to subscription agents 150.

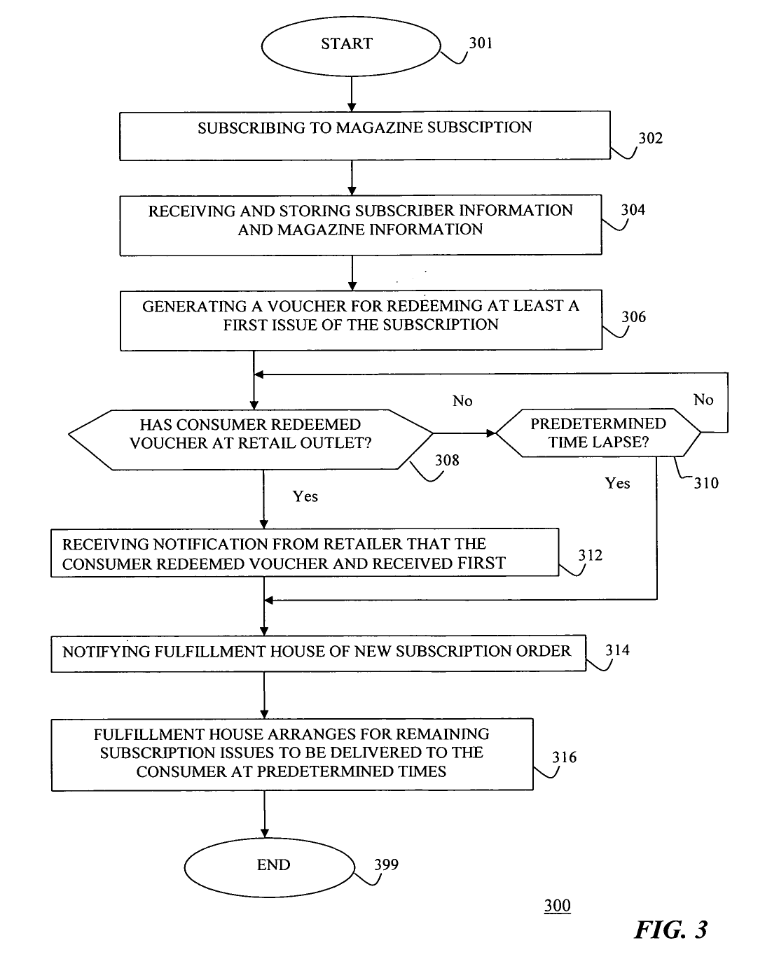

Due to a number of factors including the manner in which the various entities in the subscription distribution environment interact, the manner in which subscriptions are processed, and other factors, the fulfillment of a subscription typically requires 8 to 12 weeks of processing or other delay before a subscriber 90 begins to receive early issues of a subscription. As is illustrated in FIG. 3, a subscription may be placed 102 by depositing a blow-in or bind-in card in the mail, or otherwise providing subscription information to a subscription agent (e.g., by telephone, computer, direct mail, door-to-door sales, or any other well-known manner). Thereafter, the subscriber typically waits 8 to 12 weeks before the normal subscription delivery 104 begins. In the interim, one or more issues of the periodical are often missed by the subscriber, depending upon whether the periodical is distributed quarterly, monthly, weekly, or even daily. As a result, a subscriber is typically forced to either miss issues of the periodical or pay retail price to purchase interim issues at a retail point of sale. For a detailed understanding of the various entities and their interrelationships therebetween that form the periodic publishing and distributing industry, known systems and methods are described in U.S. Pat. No. 5,926,796 to Walker et al. and US patent no. Clarke, III et al., the contents of which are both incorporated by reference in their entireties.

To overcome the time latency deficiency as between placing an order for a subscription and actually receiving the first issue of the subscription, the present invention implements a periodical provisioning process which implements a voucher system to enable the subscriber to redeem an interim issue at a retailer. The system and method of the present invention are facilitated by the subscription agent 150 and one or more retail stores 120.

The subscription agent 150 illustratively includes a switch 160, a database server farm 152, a presentation server farm 154, an AAA (accounting/authorization/authentication) server 162, a voucher gateway 164 and a fulfillment gateway 166. The switch 160 is any conventional I/O device that transfers (i.e., routes) information between the database farm 152 and presentation server farm 154, as well as between the subscription agent 150 and external communication devices, such as a subscription transaction website 112 and retail outlets 120.

The database server farm 152 includes one or more computer devices that have a plurality of databases including a retail outlet database 222, a magazine database 224, and a fulfillment house database 226, a voucher database 228 and the like. The retail outlet database 222 includes various fields associated with each retail outlet or store that sells the various magazines and subscriptions. For example, the retail outlet database can include the names, addresses, store number info, contact information and other pertinent information of various retail stores, such as “WALMART”, “TARGET”, newsstands, convenience stores and other retail stores that sell magazines available for subscription. The retail outlets can be sorted by various fields, such as name, location, magazines sold, and the like.

The magazine database 224 includes a listing of all magazines or other periodicals that are available for sale as a subscription. The magazine database 224 can include fields associated with the retail outlets that sell the magazine, the associated fulfillment house and publisher, as well as other pertinent information.

The fulfillment house database 226 includes a listing and contact information for the fulfillment houses that process the orders for the magazines. The fulfillment house database 226 can include fields that provide contact information, as well as the publisher associated with the fulfillment house.

The voucher database 228 includes information that will be printed on a voucher 114 for the consumer to present to a retail outlet in exchange for an interim copy of the subscription. The voucher database 228 can include customer information, such as customer name and contact information, as well as the retail outlet information, such as retail outlet name and contact/address information. The voucher can also include a date of issue, as well as an expiration or timeout date.

Although the retail outlet, magazine, fulfillment and voucher databases have been described as individual databases, a person of ordinary skill in the art will appreciate that these databases are not considered limiting. Further, preferably one or more relational databases can be implemented to store and retrieve information as required.

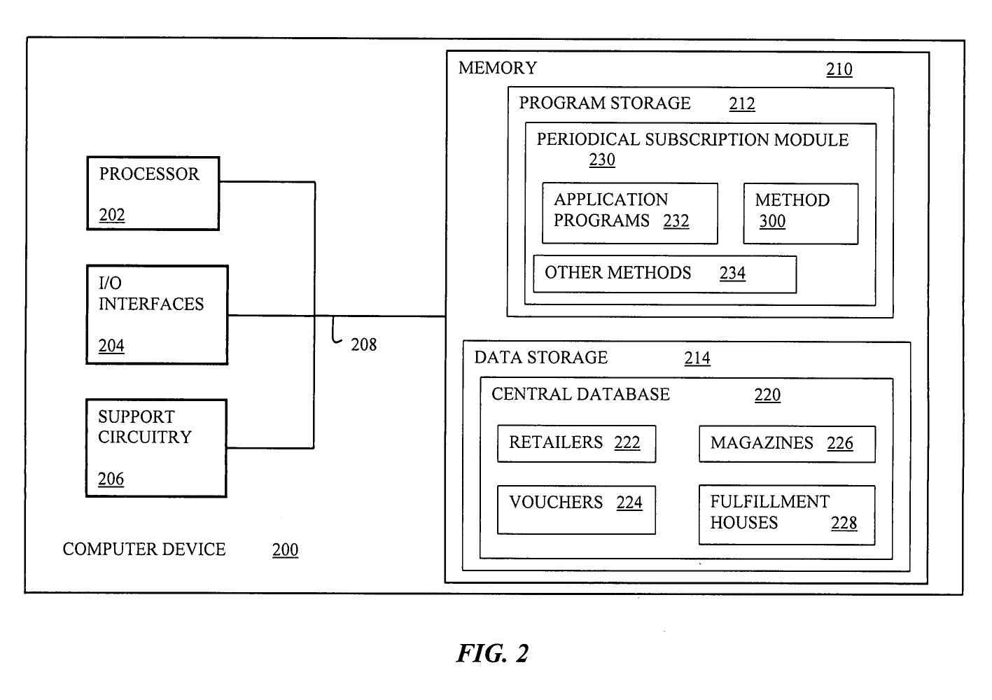

The presentation server farm 154 is one or more computer devices that include application programs 156 and logical presentation servers 158 for providing graphical user interfaces (GUIs) and other programs which the consumer 110, retail stores 120, publisher 140 and fulfillment house 130 can interact with and exchange information. The presentation server farm 154 can also include a periodical subscription module 230 of the present invention as illustratively shown in FIG. 2. The periodical subscription module 230 implements the routines and processes to carry out the present invention such as method 300 as illustratively described with respect to FIG. 3.

The AAA server 240 enables tracking the amount of network resources users are accessing and the types of services they are using. For example, system administrators might need to bill departments or customers for connection time or resources used on the network (for example, total time connected). Accounting can also be used to track suspicious connection attempts into the network. AAA authorization permits control the network services available to each user and helps restrict access to internal networks. Further, the main authentication methods considered are username and password, S/Key, token card and server, Password Authentication Protocol (PAP), among other authentication techniques

The voucher gateway 164 is an I/O device that constructs the vouchers 112 for redemption at a specified retail outlet 120. For example, the name and contact information of retail stores in a location convenient to the consumer 110 can be acquired by the voucher gateway 164 for generation of the voucher 114 by the application server 156.

The fulfillment house gateway 166 is an I/O device that provides information between the subscription agent 150 and the fulfillment houses 130. For example, the fulfillment gateway 130 can retrieve the customer information and magazine subscription information for transfer to the appropriate fulfillment house 130.

Referring to FIG. 2, a block diagram of a computer device 200 suitable for use by the subscription agent 150 of FIG. 1 is illustratively shown. The computer device 200 can be one or more servers that centrally manage subscription orders from the consumers 110 and execute programs to store periodical subscription information and perform database searches to process the subscription orders and generate vouchers for the consumers 110 to redeem at a specified retail outlet 120. The computer device 200 includes a multitasking, real-time software technology that can concurrently handle hundreds of thousands of queries and updates.

The computer device 200 can be any computer device such as a personal computer, minicomputer, workstation or mainframe, or a combination thereof. While the computer device 200 is shown, for illustration purposes, as a single computer unit, the system may typically comprise a group/farm of computers which can be scaled depending on the processing load and database size.

Specifically, the computer device 200 comprises at least one processor 202, as well as memory 210 for storing various control programs 212. The processor 202 may be any conventional processor, such as one or more “INTEL” Processors. The memory 210 can comprise volatile memory (e.g., DRAM), non-volatile memory (e.g., disk drives) and/or a combination thereof. The processor 202 cooperates with support circuitry 206, such as power supplies, clock circuits, cache memory, among other conventional support circuitry, to assist in executing software routines (e.g., method 300) stored in the memory 210. The one or more processors 202, memory 210 and support circuitry 206 are all commonly connected to each other through one or more bus and/or communication mediums (e.g., cabling) 208.

The computer device 200 also comprises input/output (I/O) circuitry that forms an interface between various functional elements communicating with the computer device 200. For example, the computer device 200 can be connected to a communication link such as the Internet or other computer network through an I/O interface 204, which receives information from and sends information over the communication link to various consumers 110 and/or retail outlets 120. Additionally, the voucher gateway 164 and fulfillment house gateway 166 of FIG. 1 can be I/O devices that communicably cooperate with the computer device 200.

The memory 210 includes program storage 212 and data storage 214. The program storage 212 stores a periodical subscription module 230 of the present invention, an operating system, such as a “WINDOWS” operating system commonly available from “MICROSOFT” Corporation, among other application programs 232 and data retrieval modules. The data storage 214 can be an internal or separate storage device, such as one or more disk drive arrays that can be accessed via the I/O interface 204 to read/write data. The data storage 214 includes one or more databases, such as a central database 220 that can store information pertaining to the retail stores or outlets 222, vouchers 224, magazines 226, fulfillment houses 228, publishers, among other information. The central database 220 can be provided internally (as shown in FIG. 2) or externally (as shown in FIG. 1) to the computer device 200. Any of the software program modules in the program storage 212 and data from the data storage 214 are transferred to specific memory locations (e.g., RAM) as needed for execution by the processor 202.

As such, it is contemplated that some of the process steps discussed herein as software processes may be implemented within hardware, for example, as circuitry that cooperates with the processor 202 to perform various steps. It is noted that the operating system (not shown) and optionally various application programs (not shown) are stored in the memory 210 to run specific tasks and enable user interaction.

Referring now to FIG. 3, a flow diagram of a method 300 for providing magazine subscriptions to a consumer in accordance with the present invention is illustratively shown. FIG. 3 should be viewed in conjunction with FIGS. 1 and 2.

The method 300 begins at step 301, where a consumer 110 is interested in obtaining a particular magazine or other periodical. The consumer 110 may wish to purchase a single issue copy of the periodical at a retail outlet 120, such as a convenience store, a book store, and the like, or purchase a subscription to the periodical for a number of issues over a predetermined time.

If the consumer 110 wishes to obtain a subscription, the consumer can proceed to a subscription transaction venue 112 to initiate the subscription for the desired periodical. For example, the consumer 110 can mail back a “blow-in” or “bind-in” card enclosed in the magazine issue obtained at a retail store 120 or at some other location. Alternatively, the consumer 110 can call one of the subscriber agents 150 to place a subscription order. Preferably, the consumer 110 orders the subscription over the Internet at a website generated by a subscription agent. Notwithstanding the consumer's preference for subscribing, at step 302, the consumer 110 subscribes to a magazine or other periodical subscription for a predetermined number of issues.

In one aspect of the present invention, the consumer 110 subscribes to a periodical using a subscription transaction website hosted by the subscription agent 150. In this embodiment, the subscription agent 150 receives and stores the consumer information and the magazine information from the website for subsequent processing as described below in further detail.

In an alternative embodiment, the consumer 110 can subscribe to the periodical by placing the subscription order with, for example, a cashier at a retail outlet 120, by telephone or some other venue for placing subscription orders. In the case where the consumer 110 places a subscription order with a cashier, the retail outlet 120 will forward the subscription information to the subscription agent 150 electronically, by means of telephone, email, or other data transfer technique. In any case where an entity other than the subscription agent 150 receives the subscription order, such entity forwards the subscription information to the subscription agent 150 for processing as described below.

At step 306, a voucher 114 is generated and provided to the consumer 110. The voucher 114 can be used by the consumer to redeem a single issue of the subscription from a retail outlet 120 that carries the periodical or magazine. For example, where the consumer 110 purchases the subscription at, illustratively, a website 112 of the subscription agent 150, then the subscription agent 150 will generate a voucher 114 that can be downloaded and/or printed by the consumer 110 at the end of the subscription transaction.

Where the consumer 110 purchases the subscription by venues other than over the internet, the voucher 114 can be delivered to the consumer by some other well-known manner, such as by email, conventional mail or by hand. For example, a consumer 110 may see a periodical that they wish to subscribe while visiting at a retail outlet, such as a book store, convenience store or other retail store having the periodical or magazine in inventory. In one embodiment, the consumer 110 can purchase the subscription along with a single issue of the periodical at the retail outlet. Alternatively, the consumer can purchase the subscription without a single issue of the periodical at the retail outlet.

In either embodiment, the cashier at the retail outlet can forward the information to the subscription agent 150, which in turn authorizes or provides back to the retailer, the voucher 114 that is given to the consumer 110. The subscriber information can be sent by scanning the bar code or UPC code of the magazine, as well as by providing information to the subscriber agent 150 electronically, e.g., over the Internet or by telephone.

In exchange for purchasing a subscription from a retail outlet 120 or other subscription transaction venue 112, the consumer 110 is given a voucher 114 that can be subsequently exchanged (i.e., redeemed) for a single issue from a retail outlet 120. The redeemed single issue from the retail outlet serves as an interim issue towards the subscription. Thus, if the consumer 110 subscribes to a magazine having twelve issues in a year, the consumer can redeem the coupon and get the most current issue as an interim issue to the subscription prior to the next issue being delivered. The fulfillment house 130 will be notified of the credit and make the necessary accounting and delivery adjustments to only deliver eleven issues, since the consumer 110 has already received the first issue of the subscription from a retail outlet 120.

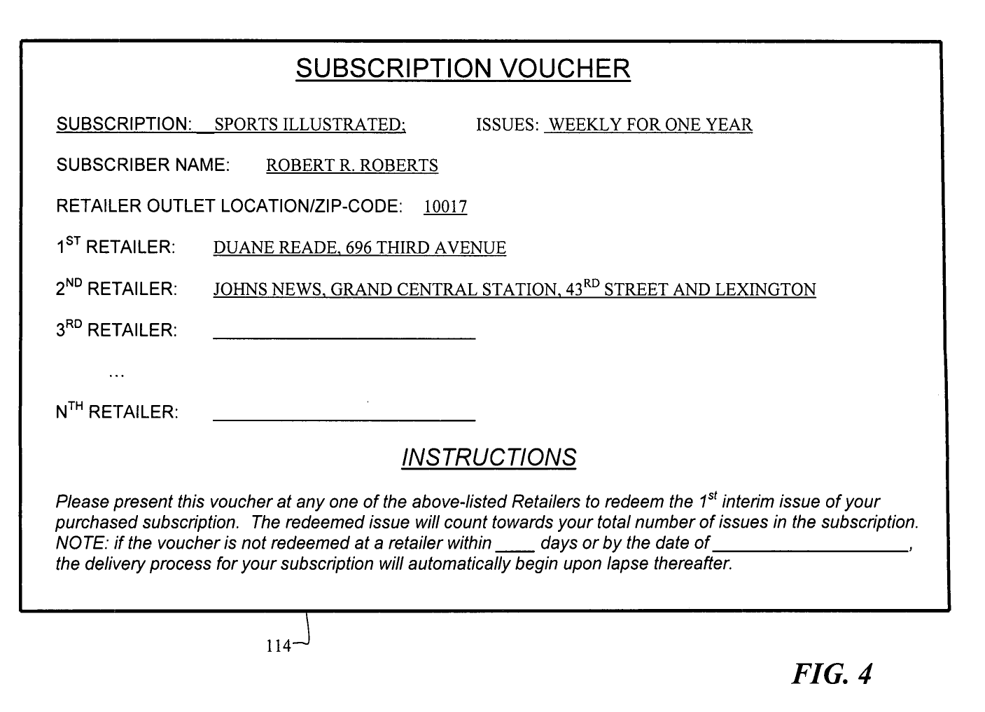

Referring to FIG. 4, an illustrative voucher 114 is shown and can include the name of the periodical or magazine that the consumer has subscribed to, as well as a convenient retail outlet to redeem the first issue of the subscription. Optionally, the voucher 114 can include other subscription information such as identification information of the consumer purchasing the subscription, the number of issues in the subscription over a specified time, alternate retail outlets 120 where the consumer can redeem the voucher 114, instructions how to redeem the voucher, a predetermined time that the voucher should or must be redeemed, and the like.

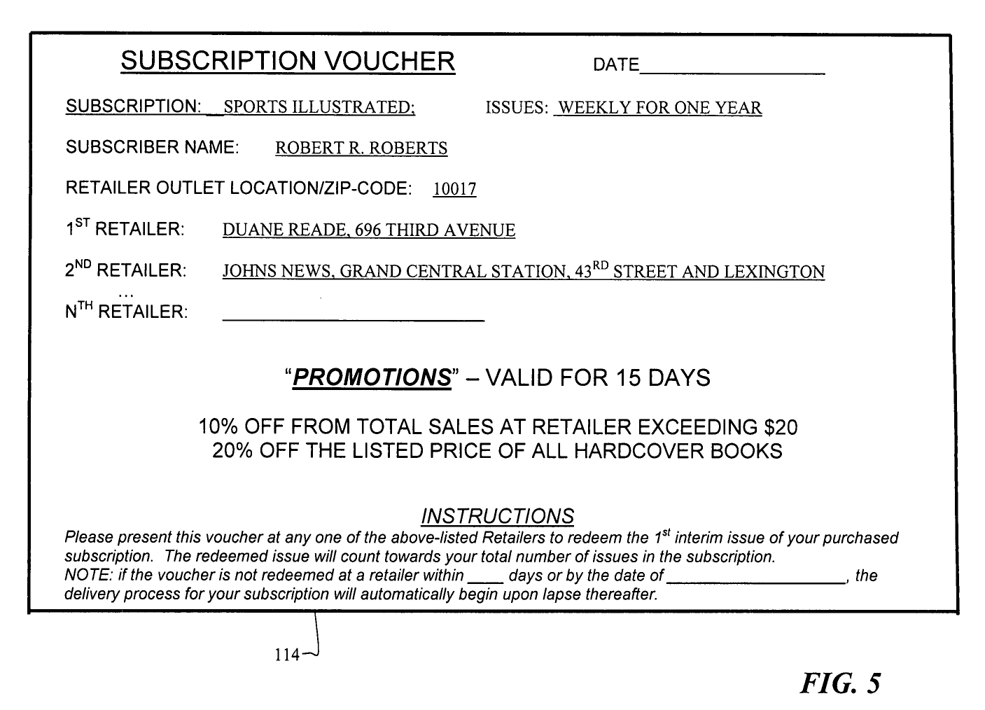

Referring to FIG. 5, another embodiment of the voucher 114 is shown. The voucher 114 of FIG. 5 is the same as the voucher of FIG. 4 except that promotional information for the retailer 120 is presented thereon. For example, promotional information can include discounts for certain stocked items to reduce inventory levels and/or receive incentives from manufacturers, encourage discounts based on total sales at the retailer, buy-one-get-one-free promotions, and the like. The consumer 110 will advantageously receive cost savings for the items being promoted, while the retailer 120 can increase sales volume. The information for generating the voucher 114 is stored in the various databases 152 of the subscriber agent 150.

For example, the voucher gateway 164 will obtain the retail outlet information used in the voucher 114 from the retail outlet database 222. The magazine information shown on the voucher is obtained from the magazine database 224. These databases are linked together to ensure that the magazine subscribed to by the subscriber is available at a particular retail outlet 120. For example, the subscription agent 150 will determine which retail outlet stores stock a selected magazine or periodical, and then provide the consumer with choices of retail outlets that are convenient (e.g., by location) to redeem the voucher 114 and receive the first issue of the subscription.

At step 308, the subscription agent 150 awaits for notification from a retailer that a consumer 110 has redeemed the voucher for an interim issue or that a predetermined time has lapsed. In particular, if a consumer 110 has not redeemed the voucher for an interim issue, the method 300 proceeds to step 310 where a determination is made whether a predetermined time has lapsed. If the predetermined time has not lapsed, then the method 300 loops back to step 308. If at step 310, the predetermined time to redeem the voucher has lapsed, then the method 300 proceeds to step 314, where the subscribing agent 150 notifies the fulfillment house to begin the subscription process for the new subscription order.

Alternatively, if at step 308, the consumer 110 has redeemed the voucher 114 for a current issue of the subscription with one of the retailers 120, then the method 300 proceeds to step 312. At step 312, the retailer 120 scans the bar code or UPC code of the redeemed issue and send the information electronically (e.g., over the internet, telephone, etc.) to the subscription agent 150. The subscription agent 150 verifies and stores the information that the consumer has received the interim issue from the retailer 120.

At step 314, the subscription agent 150 notifies the fulfillment house 130 that a new subscription has been placed by the consumer 110. Further, the subscription agent 150 informs the fulfillment house 130 that at least the first issue of the subscription has already been received by the subscribing consumer from a retail outlet 120. The method 300 then proceeds to step 316.

At step 316, the fulfillment house 130 processes the new subscription order in a well-known manner. However, the fulfillment house 130 maintains records indicating that the subscriber has received at least a first issue of the subscription from a retailer. This information is forwarded to the publisher 140 and printer 132 to ensure that the consumer does not receive a duplicate copy of the previously received interim issue, as well as to properly schedule the next issue that is to be delivered to the subscriber. Moreover, the publisher 140 and printer 132 will have been notified as to the remaining number of issues that still must be delivered to the subscriber 110. The method 300 then proceeds to step 399, where the method 300 ends.

The present invention advantageously enables “would-be” consumers 110 to conveniently subscribe to one or more periodicals or magazines of their choosing without having to wait substantially lengthy times before receiving the first issue of the subscription. In particular, the present invention implements a voucher system, which can be used to provide a single copy of the magazine or periodical from a retail outlet as an interim issue of the subscription. The fulfillment house is notified of the new subscription order once the consumer has redeemed the voucher for the interim issue or a predetermined time has lapsed and the consumer has not redeemed the voucher.

From the perspective of the consumers 110, the consumer is in control of their purchases. Single-copy magazines (purchased at newsstand, check-out aisle, etc.) are typically purchased upon impulse. That is, when a customer sees the magazine, something catches their eye on the cover or inside therein that is of interest, so they make the purchase to provide themselves with instant gratification. The element of instant gratification is currently absent in the process of buying a magazine subscription. The present invention provides a process whereby the consumer can purchase a subscription, upon impulse, knowing that they can receive instant gratification by going to a retailer right there and then and redeem their first issue. Accordingly, the present invention empowers the consumer by enabling the ability to get the first issue in their control (as opposed to the Clarke's patent, where although there is an interim issue being redirected, the consumer still does not really know when it will come, just that it will come sooner than traditional delivery).

Further, the consumer typically makes a purchasing decision for the subscription based upon the cover image of a title, which is usually one they will never receive, because traditional delivery is 6-10 weeks out. Conversely, the present invention enables the consumer to receive the current issue to enjoy the benefits of instant gratification. Accordingly, the present invention allows the consumer to entirely control the process of starting that subscription.

The present invention is further advantageous to publishers, as it helps preserve goodwill by delivering a superior experience to the customers. As described above, the present invention provides a superior solution for the consumer, particularly as it relates to starting a subscription. These benefits carry over to the publisher by, e.g., improving good will and overall customer experience. The present invention drastically shortens the gap between when a consumer places an order and first engages with the magazine brand. Conversely, the delays associated with the prior art from the order being placed to actually receiving the first subscription create a disconnect (from the impulse buy) and arguably a disinterest or loss of engagement with the magazine and its brand. For example, even if system disclosed in Clarke's “redirects interim issues”, the customer still doesn't really know when it's coming. The present invention overcomes this deficiency by enabling a consumer to immediately begin engaging with the magazine, the brand, and the feeling of being a subscriber and customer.

From the perspective of the retailers, the retailers will advantageously realize increased foot-traffic and sales. Additionally, the waste of resources can be reduced with respect to both people (that have to pack, ship back to distributors, shred) and the useless wasting and shredding of magazines. Advantageously, the present invention provides the ability to drive consumers into their retail locations, which is likely to stimulate additional sales in the store.

It will be apparent to those of ordinary skill in the art that various modifications and variations can be made to the present invention without departing from the spirit and scope of the invention. Thus, it is intended that the present invention cover the modifications and variations of this invention that come within the scope of the appended claims and their equivalents.

What is claimed is:

1. A method for fulfilling a periodical subscription to a consumer, the periodical subscription including a predetermined number of issues and associated delivery dates, the method comprising the steps of:
receiving a subscription order for a periodical having a plurality of issues deliverable to the consumer at a consumer premises;
generating a subscription order voucher for redeeming an interim periodical issue prior to the consumer receiving delivery of a first issue of the subscription at the consumer premises from a fulfillment house, said voucher including authorization for a retail location to provide the interim issue of the periodical subscription to the consumer upon presentation; and
communicating subscription information associated with the consumer to the fulfillment house following one of redemption of the voucher by the consumer for the interim issue or a predetermined time having elapsed.

2. A system for fulfilling a periodical subscription to a consumer, the periodical subscription including a predetermined number of issues and associated delivery dates, the system including at least one computer device having memory for storing a periodical subscription module and a processor for executing instruction therefrom, said computer device operable to:
receive a subscription order for a periodical having a plurality of issues deliverable to the consumer at a consumer premises;
generate a subscription order voucher for redeeming an interim periodical issue prior to the consumer receiving delivery of a first issue of the subscription at the consumer premises from a fulfillment house, said voucher including authorization for a retail location to provide the interim issue of the periodical subscription to the consumer upon presentation; and
communicate subscription information associated with the consumer to the fulfillment house following one of redemption of the voucher by the consumer for the interim issue or a predetermined time having elapsed.

3. Apparatus for fulfilling a periodical subscription to a consumer, the periodical subscription including a predetermined number of issues and associated delivery dates, the apparatus comprising:
means for receiving a subscription order for a periodical having a plurality of issues deliverable to the consumer at a consumer premises;
means for generating a subscription order voucher for redeeming an interim periodical issue prior to the consumer receiving delivery of a first issue of the subscription at the consumer premises from a fulfillment house, said voucher including authorization for a retail location to provide the interim issue of the periodical subscription to the consumer upon presentation; and
means for communicating subscription information associated with the consumer to the fulfillment house following one of redemption of the voucher by the consumer for the interim issue or a predetermined time having elapsed.

4. The apparatus of claim 3, wherein the means for receiving a subscription order is a subscription agent.
